(19) United States
(12) Patent Application Publication
(10) Pub. No.: US 2026/0356715 A1
(43) Pub. Date: Nov. 12, 2026

(54) Zero Liquid Discharge

(71) Applicant: Bell Engineering, Inc., Beaumont, TX (US)

(72) Inventor: Robert Richardson, Beaumont, TX (US)

(73) Assignee: Bell Engineering, Inc., Beaumont, TX (US)

(21) Appl. No.: 19/658,440

(22) Filed: Apr. 24, 2026

Related U.S. Application Data
(60) Provisional application No. 63/801,780, filed on May 7, 2025.

(51) Int. Cl. C02F 9/00; B01D 53/04; B01D 53/52; B01D 53/78; E03B 3/00; C02F 1/00; C02F 1/04; C02F 1/06; C02F 1/20; C02F 1/28; C02F 1/40; C02F 1/52; C02F 101/10; C02F 101/32; C02F 103/10

(52) U.S. Cl. CPC C02F 9/00; B01D 53/04; B01D 53/52; B01D 53/78; E03B 3/00; B01D 2253/102; B01D 2257/304; B01D 2257/708; B01D 2258/02; C02F 2001/007; C02F 1/041; C02F 1/06; C02F 1/20; C02F 1/283; C02F 1/40; C02F 2001/5218; C02F 2101/101; C02F 2101/322; C02F 2103/10; C02F 2301/08; C02F 2303/10

(57) ABSTRACT

A method and apparatus for separating a saltwater/oil mix from a wellsite that includes separating the oil and water to form a brine solution, flashing the brine solution using one or more flash tanks into a water vapor for condensing into an acceptable freshwater for well production uses and creating a brine solution that allows for the removal of the unwanted salts and other chemicals.

### RELATED APPLICATIONS

This application claims priority to U.S. Provisional Application No. 63/801,780, filed May 7, 2025.

### BACKGROUND

Production of fresh water economically is a worldwide issue. This document outlines the ZLD system's design, operation, economic value, and its suitability for field deployment in harsh U.S. environments.

Texas faces a growing and well-documented water supply challenge due to population growth, drought, industrial use, and declining aquifer levels. According to the Texas Water Development Board (TWDB), the state’s population is projected to increase from approximately 29 million in 2020 to over 51 million by 2070. Over the same period, water demand is expected to increase by over 17%, while existing water supplies are projected to decline by nearly 11% due to aquifer depletion and climate volatility.

Key sectors at risk include: Municipal supply in high-growth regions (e.g., Central Texas, DFW, San Antonio, and Houston corridors), agriculture, particularly in the Rio Grande Valley and West Texas where irrigation relies on diminishing groundwater, energy production, especially in the Permian and Delaware basins where oil and gas development generate large volumes of produced water with limited reuse options.

Texas currently relies on surface water, groundwater, and some brackish desalination (mostly brackish RO) to meet demand. There are over 50 municipal brackish RO plants in Texas, yet these face constraints from: High membrane fouling and scaling risk, concentrated brine disposal challenges (especially inland), high capital and electrical energy requirements, and limited tolerance for highly variable or contaminated water sources.

### SUMMARY OF EXAMPLE EMBODIMENTS

An example embodiment may include a novel Zero-Liquid Discharge (ZLD) desalination system utilizing direct-contact gas heating, flash evaporation under vacuum, and salt crystallization. The system may be designed for use in Texas and across the U.S. for processing seawater, produced water, and salt-contaminated groundwater.

This ZLD flash crystallizer system offers a uniquely modular, low-energy, and low-maintenance approach to high-salinity water treatment and reuse. Unlike conventional systems, it eliminates brine discharge, operates under low pressure and temperature, and uses readily available natural gas instead of large electrical infrastructure.

This technology fills a critical gap in Texas and U.S. water supply strategy by enabling water recovery from sources that are currently considered unusable, without creating a new waste stream. It is well positioned for both commercial success and regulatory support.

An example embodiment may include a method for a zero liquid discharge desalination process comprising flashing produced water in a plurality of flash tanks to produce a first, second, and third vapor stream, and a first, second, and third liquid stream, pressurizing the first, second, and third liquid streams to saturation pressure, circulating the first vapor stream through a first condensation loop, circulating the second vapor stream through a second condensation loop, circulating the third vapor stream through a third condensation loop, compressing the third vapor stream, transferring the latent heat of the third vapor stream into sensible heat in the first liquid stream, condensing the third vapor stream into a first distillate stream, circulating the heated first liquid stream into the at least one flash tank, and depressurizing the heated first liquid stream, wherein the depressurized heated first liquid stream boils due to the added sensible heat.

A variation of the example embodiment may include transferring the latent heat of the first vapor stream into sensible heat in the second liquid stream. It may include depressurizing the heated second liquid stream, wherein the depressurized heated second liquid stream boils due to the added sensible heat. It may include condensing the first vapor stream into a second distillate stream. It may include transferring the latent heat of the second vapor stream into sensible heat in the third liquid stream. It may include depressurizing the heated third liquid stream, wherein the depressurized heated third liquid stream boils due to the added sensible heat. It may include condensing the second vapor stream into a third distillate stream. It may include circulating a liquid brine stream in a solids removal loop, wherein solids are removed from the liquid brine stream, and the remaining liquid is returned to the plurality of flash tanks. It may include agitating the produced water in the plurality of the flash tanks, wherein the flash tank includes a deflector disk at its base that directs incoming flow radially outward to suspend solids and prevent their accumulation at the bottom of the flash tank, without moving parts. It may include combining the first, second, and third distillate streams to form a combined distillate stream. It may include filtering combined distillate water stream through a carbon filter.

An example embodiment may include a method for treating produced water comprising separating oil from the produced water by gravity separation to produce a deoiled water stream, removing dissolved H₂S and volatile organic compounds from the deoiled water stream by vacuum degassing prior to the evaporating step, evaporating the pretreated water in at least one vacuum flash evaporator to produce a first vapor stream, a first liquid stream, and a first concentrated brine stream, pressurizing the first liquid stream at or above its saturation pressure, pressurizing the first vapor stream, exchanging heat between the first vapor stream and the first liquid stream to produce a first distillate liquid stream and a heated first liquid stream, lowering the pressure of the first liquid stream prior to reentering the at least one vacuum flash evaporator, wherein the lower pressure causes the heated first liquid stream to boil inside the flash evaporator.

A variation of the example embodiment may include removing solids from the first concentrated brine stream and recirculating the first brine stream into the at least one vacuum flash evaporator. It may include crystallizing salts from the first concentrated brine stream. The first vapor stream may be pressurized using a mechanical vapor recompression pump. It may include agitating the fluid in the at least one vacuum flash evaporator. The lowering of the pressure of the first vapor liquid stream may utilize a letdown valve. The agitation may be achieved using a deflector disk located inside the at least one vacuum flash evaporator. The exchanging heat between may involve removing the latent heat from the first vapor stream and adding it as sensible heat into the first liquid stream. The gravity separation may be performed in a vessel equipped with chevron-coalescing packing. Dissolved gases may be released during vacuum degassing may be captured in a caustic scrubber for H₂S removal and a granular activated carbon contactor for VOC removal.

### BRIEF DESCRIPTION OF THE DRAWINGS

For a thorough understanding of the example embodiments, reference is made to the following detailed description of the embodiments, taken in conjunction with the accompanying drawings in which reference numbers designate like or similar elements throughout the several figures of the drawing. Briefly:

FIG. 1 is a diagram of an example embodiment of a ZLD system.

FIG. 2 is a diagram of an example embodiment of a ZLD system.

FIG. 3 is a diagram of an example embodiment of a single effect ZLD system.

FIG. 4 is a diagram of an example embodiment of a double effect ZLD system.

FIG. 5 is a diagram of an example embodiment of a triple effect ZLD system.

FIG. 6A is a top view of an example embodiment of a deflector plate assembly for a flash tank evaporator inlet.

FIG. 6B is a cross section view of an example embodiment of a deflector plate assembly for a flash tank evaporator inlet.

### DETAILED DESCRIPTION OF THE EXAMPLE EMBODIMENTS

In the following description, certain terms have been used for brevity, clarity, and examples. No unnecessary limitations are to be implied therefrom and such terms are used for descriptive purposes only and are intended to be broadly construed. The different apparatus, systems and method steps described herein may be used alone or in combination with other apparatus, systems and method steps. It is to be expected that various equivalents, alternatives, and modifications are possible within the scope of the appended claims.

An example embodiment may include a ZLD flash desalination system that can address several gaps in the current water strategy by: 1) treating produced water on-site in oilfields, turning a waste liability into a freshwater source for reuse or agriculture, 2) recovering water from inland saltwater wells with no brine discharge, eliminating the need for deep well injection or evaporation ponds, 3) augmenting brackish RO plants by handling their concentrate as a secondary stream, reducing overall liquid discharge and improving sustainability, and 4) 0perating off-grid or on flare gas where electricity is limited or unavailable.

An example ZLD desalination system operates by heating saline or contaminated water to 140–160°F (60–70°C) using a direct-contact natural gas spray tower. This heated water enters an agitated vacuum flash tank operating at approximately 1.5–2.5 psia (6–12 kPa absolute), where a portion of the water flashes into vapor.

The flashed vapor may be routed to a vapor dome and then to a plate condenser. The condenser uses a closed-loop low-boiling working fluid (e.g., n-pentane), which absorbs the latent heat of condensation, evaporates, and is subsequently cooled by an air-cooled condenser to complete the cycle. This approach allows for effective heat recovery and keeps the entire process low-pressure and low temperature.

Brine remaining in the flash tank is continuously recirculated through an auto-cleaning screen to remove precipitated salt. These solids are sent to a dewatering screen and eventually to a drying bin. Any remaining water in the bin evaporates passively, achieving zero liquid discharge (ZLD).

Another example embodiment may include using the disclosed ZLD processes to produce water for use in new drilling operations, formation fracking, and well stimulation. The ZLD processes can be used to reduce salt in salt water being used in oilfield operations, which reduces salt that can precipitate out of the salt water and cause fouling of the formation or the oilfield equipment.

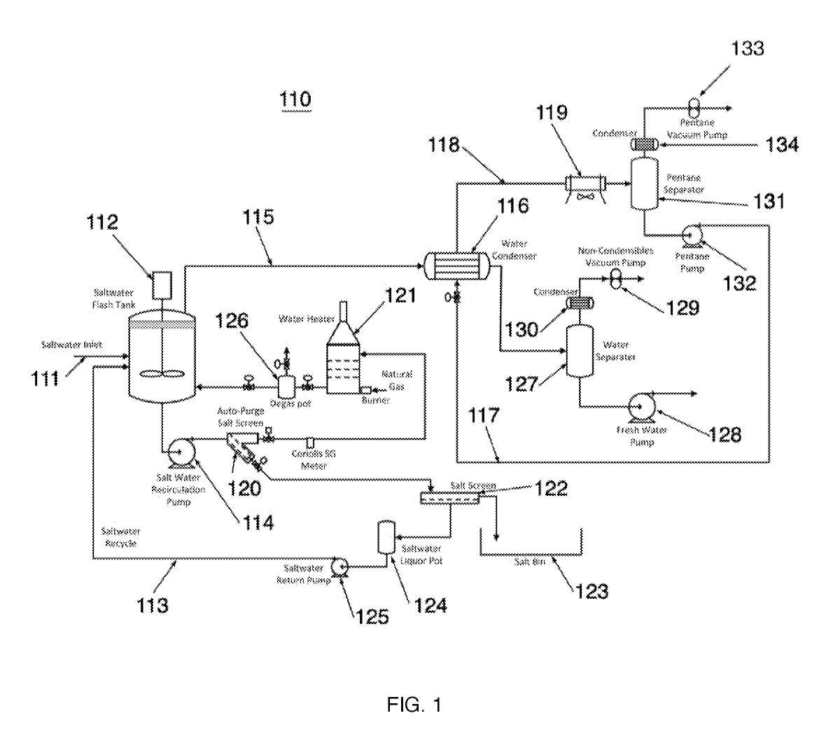

An example embodiment in FIG. 1 shows a ZLD system 110 that has a saltwater inlet 111 supplying the saltwater flash tank 112. The water vapor 115 supplies the water side of a heat exchanger 116. A pentane loop 117 supplies the coolant side of the heat exchanger 116. A mix of condensed and liquid water leaves the heat exchanger and goes to a water separator 127. Fresh water pump 128 removes the fresh water from the water separator 127 and the non-condensable vacuum pump removes the non-condensable via a condenser 130. The vaporized pentane 118 leaving the heat exchanger 116 passes through the air cooler 119. The resultant cooled pentane enters a pentane separator 131. The pentane is removed by pentane pump 132 and recirculated via the pentane loop 117. The remaining vapors are condensed by condenser 134 and removed via pentane vacuum pump 133.

The pentane loop disclosed can be replaced with mechanical vapor recompression design as shown in other example embodiments disclosed herein. In an MVR design the vapor condenser may be moved to the brine recirculation loop to allow for the latent heat of the condensing the water vapor may be used to heat the recirculated brine prior to flashing.

Fired or electric heaters may maintain too high of a skin temperature, which leads to salt scaling and fouling, therefore indirect heating using a heated water/glycol recirculation is a suitable alternative embodiment.

Mechanical agitation may be used in the flash tank as well as other examples, such as turbulent flow to prevent settling.

In one variation, the water vapor 115 from the flash tank 112 enters the condenser side of a plate-type or tube-in-shell heat exchanger 116. The latent heat from condensing water is transferred to the pentane, which vaporizes on the other side of the heat exchanger 16. The vaporized pentane 118 is routed to an air-cooled condenser 119, where it is cooled and returned to liquid form.

A saltwater recirculation pump 114 pumps saltwater to an auto-purge salt screen 120 that distributes salt water to a water heater 121 and a salt screen 122. The salt screen 122 separates water to a salt bin 123 and a saltwater liquor pot 124. A saltwater return pump 125 pumps the saltwater recycle fluid 113 back into the saltwater flash tank 112. The water heater 121, in this example, uses a natural gas-powered burner, heats the saltwater and sends the heated water to a degas pot 126. The degassed water is then fed back into the saltwater flash tank 112.

Referring to FIG. 1, the example embodiment uses the low boiling point working fluid, such as, but not limited to n-pentane, in a closed-loop condensation cycle to absorb the latent heat of condensing water vapor, removing the need for direct water-based cooling, mechanical vapor compression, or seawater intake systems. N-Pentane boils at ~97°F (36°C), which aligns well with water vapor condensing at ~110–120°F (43–49°C) under vacuum. Maintain the pentane vapor pressure between 5–6 psia will and it will still condense at ~110°F. Pentanes are chemically stable under the system's mild temperature range, with no scaling or corrosion issues.

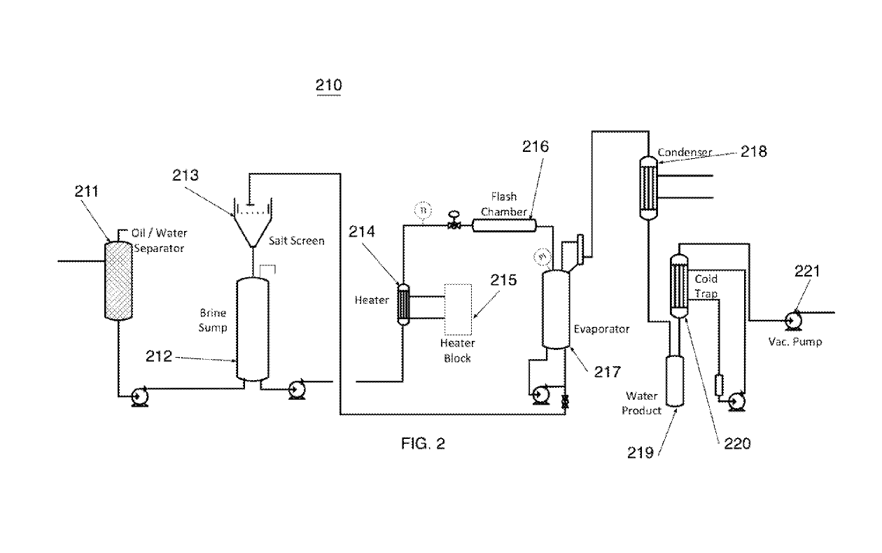

Referring to FIG. 2, an example embodiment of a ZLD Desalination forced circulation flash loop 210 may including flowing a fluid into an oil/water separator 211. A brine sump 212 removes the brine from the oil/water separator 211 via a pump. The brine is then pumped into heater 214 which is powered by heater block 215. The heated fluid is then flowed into the flash chamber 216. The flashed fluid then flows into the evaporator 217 where a portion evaporates out of the fluid, where it is condensed in condenser 218. A liquid portion is pumped out of evaporator 217 and sent to a salt screen 213, the resulting fluid is then sent back into the brine sump 212.

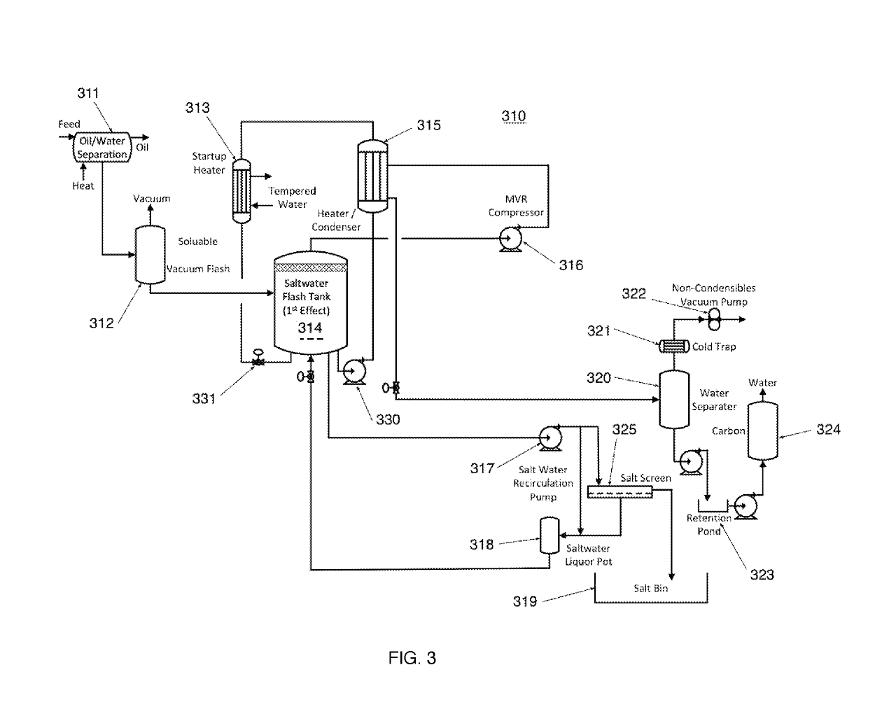

Referring to FIG. 3, an example of a single effect ZLD Desalination Process 310. Produced water, for example from a wellpad, is sent into an oil/water separator 311. The separator 311 may use a gravity separation, it may be equipped with a chevron-coalescing package, and it may use heat to aid the separation. Structured baffles may be used to create a low-velocity zone where entrained oil droplets coalesce and float to the surface for skimming, while solids settle to the sump. No chemicals are required at this stage.

A vacuum chamber 312 is used to draw out water from the separator 311 and then send that fluid into a first saltwater flash tank 314. The de-oiled water enters a vacuum degassing vessel 312 operating at reduced absolute pressure. Dissolved H₂S and BTEX volatiles flash out of solution and are captured in a caustic scrubber (H₂S removal >99%) and a granular activated carbon (GAC) canister (BTEX removal >90%) before discharge to a safe vent or flare. Both H₂S and BTEX concentrate in the vapor phase during evaporation and would contaminate the distillate product without upstream removal. After degassing, the water is pH-adjusted to 6.8–7.2 and dosed with an anti-scalant formulation selected for the specific ion activity product of the feed water across all evaporator temperature stages simultaneously.

The flash tank 314 has a recirculation loop that uses a first liquid brine stream pumped via pump 330 to its saturation pressure from the flash tank 314 to the condenser 315 and back through a startup heater 313 used primarily for startup operations, and finally through a letdown valve 331 that prevents the first liquid brine stream from boiling in the loop. The pump 330 increases the pressure of the first liquid brine stream.

The flash tank 314 has a steam loop that uses a first vapor stream that is compressed using an MVR compressor 316 to pressurize and further heat the vapor stream. It is then sent through the condenser 315 where it interacts with the relatively cooler pressurized first liquid brine stream. The latent heat from the vapor of flash tank 314 is absorbed as sensible heat into the liquid of the recirculation loop. The vapor stream condenses to a liquid while the extra heat added to the first liquid brine stream does not boil the liquid because it is at its saturation temperature. When the first liquid brine stream passes through letdown valve 331, it partially flashes to steam as it enters the flash tank 314. The interactions of the recirculation loop and the steam loop allow the condensation of distilled liquid and transfers the heat from the MVR compressor 316 into the flash tank to generate additional vapor for the steam loop.

The flash tank 314 has a solids removal loop that uses a second liquid brine stream that is pumped out via pump 317. The concentrated brine in the second brine stream exiting the flash tank 314 — typically at 80–90% of saturation — feeds a draft-tube baffled (DTB) crystallizer 325 operating under vacuum at approximately 35–45°C. High-velocity recirculation through a submerged propeller and draft tube maintains uniform supersaturation, promoting growth of large, filterable crystals (target median size 200–500 microns) rather than fine, hard-to-process fines. Salt crystals from the crystallizer 325 are sent to the salt bin 319.

A controlled mother-liquor pot 318 feeds back to the flash tank 314 inlet at a rate and point specifically set to maintain crystal growth rate within the target size distribution.

Crystal slurry from the crystallizer (15–25 wt% solids) is fed to a filter 325, which could be for example a shaker screen, centrifuge, or vacuum belt. The dewatered salt cake exits to bin 319 at 8–15% moisture. Mother liquor (brine or saltwater) recovered from the separator is returned via saltwater liquor pot 318 to the flash tank 314, closing the liquid loop completely.

The output flow from the letdown valve 331 can be combined with the output flow from saltwater liquor pot 318 prior to entering the flash tank 314.

The pretreated brine enters a vacuum evaporation train of one, two, or three stages — referred to as effects. In the example of FIG. 3 there is one stage, or one effect, in vacuum chamber 312. The number of effects is selected based on capital budget, available operating cost tolerance, expected run life, and site energy infrastructure. All configurations operate within the same 45–68°C low-temperature regime and achieve full ZLD; the effect count determines thermal efficiency, not process completeness. In a multi-effect configuration, each stage operates at a successively lower absolute pressure, which lowers the boiling point and allows the steam vapor generated in one effect to serve as the heat source for the next — without any additional external steam input between stages.

By way of example, all configurations in the example embodiments, including the single, double, and triple effect examples herein, may operate at 45–68°C across their respective effects. Steam economy ranges from approximately 0.9 kg evaporated per kg of live steam (single- effect) to ~2.0 (two-effect) to ≥ 2.6 (three-effect), representing energy reductions of roughly 0%, 55%, and 65–70% respectively compared to single-effect at equivalent throughput. The right configuration depends on whether capital cost or long-term energy cost is the binding constraint at a given site.

For example, a liquid-ring vacuum pump 322 maintains the sub-atmospheric pressure in the vapor train and handles non-condensable gas (NCG) removal. A shell-and-tube condenser 315 downstream of the vapor train condenses the steam from the final effect and recovers it as clean distillate. Cold trap 321 protects the vacuum pump 322 from liquid carry-over, knocking any liquid back into the water separator 320.

Optional mechanical vapor recompression via MVR compressor 316 can be integrated between effects to compress low-pressure vapor back to a usable heating pressure via condenser 315, effectively replacing most or all external steam input with electrical energy from a compressor.

The salt cake — predominantly NaCl with CaCl₂, MgCl₂, and minor mineral fractions — passes TCLP toxicity testing under standard conditions and is managed in an on-site Class II landfill permitted under Texas Railroad Commission Rule 3.8 (16 TAC Chapter 3). The landfill includes a compacted clay/HDPE liner system, a leachate collection layer, and groundwater monitoring. Leachate (primarily brine from rainwater infiltration) is returned to the ZLD feed tank, maintaining full closure. NORM (naturally occurring radioactive material — primarily Ra-226 and Ra-228) co-precipitates with BaSO₄ during evaporation and concentrates in the salt cake. In most Permian applications, NORM levels in the crystallized NaCl-dominant cake are within Class II landfill thresholds (50–200 pCi/g). Salt cake is tested prior to each landfill placement.

Distillate leaving the condenser 315 at less than 50 mg/L TDS meets oilfield reuse standards without further treatment. For municipal water supply, agricultural irrigation, or other broader beneficial end uses, an additional polishing stage is incorporated. This stage consists of two elements in series: a retention pond 323 followed by a granular activated carbon (GAC) contactor operated 324 on a contingency basis.

Distillate flows into a lined retention pond 323 sized for a minimum residence time of 24–72 hours. The pond 323 serves three functions. First, it provides a buffer volume that decouples the evaporator’s production rate from the downstream distribution schedule, allowing continuous evaporator operation regardless of demand variability. Second, residence time allows any residual trace volatiles that survived pretreatment and evaporation to off-gas to atmosphere passively — a final vapor-stripping step at no additional energy cost. Third, and most importantly for regulatory purposes, the pond is a defined quality hold point: the water is sampled and tested against applicable end-use standards before release. If a sample fails, the affected volume is held and recycled back to the ZLD feed tank rather than released downstream. This built-in quality gate is the key regulatory assurance feature that supports permitting for agricultural or municipal use — treated water does not leave the facility boundary until it has been confirmed to meet the target standard.

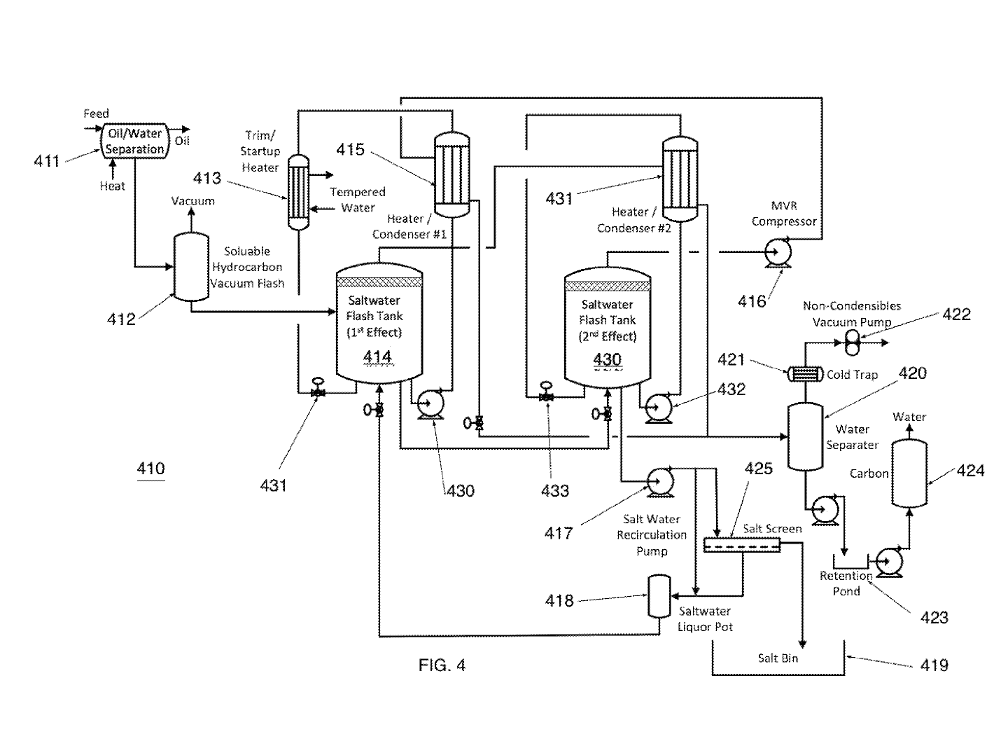

Referring to FIG. 4 an example of a double effect ZLD Desalination Process 410. Produced water, for example from a wellpad, is sent into an oil/water separator 411. The separator 411 may use a gravity separation, it may be equipped with a chevron-coalescing package, and it may use heat to aid the separation. Structured baffles may be used to create a low-velocity zone where entrained oil droplets coalesce and float to the surface for skimming, while solids settle to the sump. No chemicals are required at this stage.

A vacuum chamber 412 is used to draw out water from the separator 411 and then send that fluid into a first saltwater flash tank 414. The de-oiled water enters a vacuum degassing vessel 412 operating at reduced absolute pressure. Dissolved H₂S and BTEX volatiles flash out of solution and are captured in a caustic scrubber (H₂S removal >99%) and a granular activated carbon (GAC) canister (BTEX removal >90%) before discharge to a safe vent or flare. Both H₂S and BTEX concentrate in the vapor phase during evaporation and would contaminate the distillate product without upstream removal. After degassing, the water is pH-adjusted to 6.8–7.2 and dosed with an anti-scalant formulation selected for the specific ion activity product of the feed water across all evaporator temperature stages simultaneously.

The first flash tank 414 has a first recirculation loop that uses a first liquid brine stream pumped via pump 430 to its saturation pressure from the first flash tank 414 to the condenser 415 and back through a startup heater 413 used primarily for startup operations, and finally through a letdown valve 431 that prevents the first liquid brine stream from boiling in the loop. The pump 430 increases the pressure of the first liquid brine stream.

The flash tank 430 has a second recirculation loop that uses a second liquid brine steam pump via pump 432 to its saturation pressure from the second flash tank 430 to the condenser 431 and back through a letdown valve 433.

The second flash tank 430 has a second steam loop that uses a second vapor stream that is compressed using an MVR compressor 416 to pressurize and further heat the second vapor stream. It is then sent through the condenser 415 where it interacts with the relatively cooler pressurized first liquid brine stream from the first flash tank 414. The vapor stream condenses to a liquid while the extra heat added to the first liquid brine stream does not boil the liquid because it is at its saturation temperature. When the first liquid brine stream passes through letdown valve 431, it partially flashes to steam as it enters the flash tank 414. The interactions of the first recirculation loop and the second steam loop allow the condensation of distilled liquid and transfers the heat from the MVR compressor 416 into the first flash tank 414 to generate additional vapor for the steam loop.

The first flash tank 414 sends its vapor, the first vapor stream, to condenser 431 that is part of the second recirculation loop from flash tank 430. The second condenser 431 condenses the first vapor stream from the first flash tank 414 and combines it with the condensed liquid from the second condenser 432. The latent heat from the first vapor stream of flash tank 414 is absorbed as sensible heat into the second recirculation loop but does not boil the fluid in the second recirculation loop because of letdown valve 433. After passing through letdown valve 433 the fluid boils from the added latent heat as it is recombined with the second flash tank 430. In this example, the heat from MVR compressor 416 is adding heat to flash tank 414 and flash tank 414 is adding heat to the second flash tank 430, at the same time producing distilled liquid from the first condenser 415 and second condenser 431.

The first flash tank 414 and second flash tank 430 has a solids removal loop that uses a second liquid brine stream that is pumped out via pump 417. The concentrated brine in the second brine stream exiting the flash tank 430 — typically at 80–90% of saturation — feeds a draft-tube baffled (DTB) crystallizer 425 operating under vacuum at approximately 35–45°C. High-velocity recirculation through a submerged propeller and draft tube maintains uniform supersaturation, promoting growth of large, filterable crystals (target median size 200–500 microns) rather than fine, hard-to-process fines. Salt crystals from the crystallizer 425 are sent to the salt bin 419.

Crystal slurry from the crystallizer (15–25 wt% solids) is fed to a filter 425, which could be for example a shaker screen, centrifuge, or vacuum belt. The dewatered salt cake exits to bin 419 at 8–15% moisture. Mother liquor (brine or saltwater) recovered from the separator is returned via saltwater liquor pot 418 to the flash tank 414, closing the liquid loop completely.

The output flow from the letdown valve 431 can be combined with the output flow from saltwater liquor pot 418 prior to entering the flash tank 414.

The pretreated brine enters a vacuum evaporation train of one, two, or three stages — referred to as effects. In the example of FIG. 4 there are two stages, or two effects. The number of effects is selected based on capital budget, available operating cost tolerance, expected run life, and site energy infrastructure. All configurations operate within the same 45–68°C low-temperature regime and achieve full ZLD; the effect count determines thermal efficiency, not process completeness. In a multi-effect configuration, each stage operates at a successively lower absolute pressure, which lowers the boiling point and allows the steam vapor generated in one effect to serve as the heat source for the next — without any additional external steam input between stages.

For example, a liquid-ring vacuum pump 422 maintains the sub-atmospheric pressure in the vapor train and handles non-condensable gas (NCG) removal. As an example, a shell-and-tube condensers 415 and 431 can be used to condense the steam from each effect and recovers it as clean distillate. Cold trap 421 protects the vacuum pump 422 from liquid carry-over, knocking any liquid back into the water separator 420.

Optional mechanical vapor recompression via MVR compressor 416 can be integrated between effects to compress low-pressure vapor back to a usable heating pressure effectively replacing most or all external steam input with electrical energy from a compressor.

The salt cake — predominantly NaCl with CaCl₂, MgCl₂, and minor mineral fractions — passes TCLP toxicity testing under standard conditions and is managed in an on-site Class II landfill permitted under Texas Railroad Commission Rule 3.8 (16 TAC Chapter 3). The landfill includes a compacted clay/HDPE liner system, a leachate collection layer, and groundwater monitoring. Leachate (primarily brine from rainwater infiltration) is returned to the ZLD feed tank, maintaining full closure. NORM (naturally occurring radioactive material — primarily Ra-226 and Ra-228) co-precipitates with BaSO₄ during evaporation and concentrates in the salt cake. In most Permian applications, NORM levels in the crystallized NaCl-dominant cake are within Class II landfill thresholds (50–200 pCi/g). Salt cake is tested prior to each landfill placement.

Distillate leaving the condenser 415 and 431 at less than 50 mg/L TDS meets oilfield reuse standards without further treatment. For municipal water supply, agricultural irrigation, or other broader beneficial end uses, an additional polishing stage is incorporated. This stage consists of two elements in series: a retention pond 423 followed by a granular activated carbon (GAC) contactor operated 424 on a contingency basis.

A controlled mother-liquor recycle loop 418 feeds back to the flash tank 414 inlet at a rate and point specifically set to maintain crystal growth rate within the target size distribution.

Crystal slurry from the flash tank 430 is fed to a filter 425, which could be for example a shaker screen, centrifuge, or vacuum belt. The dewatered salt cake exits to bin 419 at 8–15% moisture. Mother liquor (brine or saltwater) recovered from the separator is returned via saltwater liquor pot 418 to the flash tank 414, closing the liquid loop completely. The output flow from heater 413 can be combined with the output flow from saltwater liquor pot 418 prior to entering the flash tank 414.

Distillate leaving the condensers 415 and 431 at less than 50 mg/L TDS meets oilfield reuse standards without further treatment. For municipal water supply, agricultural irrigation, or other broader beneficial end uses, an additional polishing stage is incorporated. This stage consists of two elements in series: a retention pond 423 followed by a granular activated carbon (GAC) contactor operated 424 on a contingency basis. A vacuum chamber 412 is used to draw out water from the separator 411 and then send that fluid into a first saltwater flash tank 414 and then to a second saltwater flash tank 430.

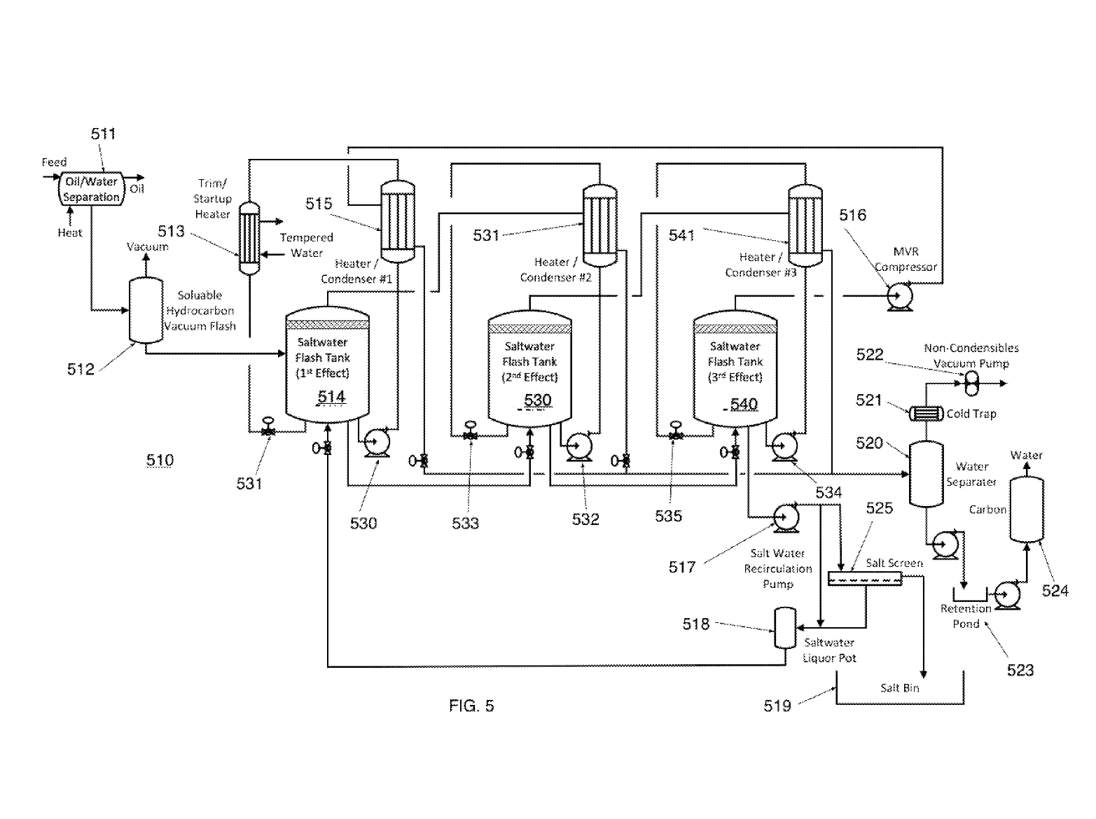

An example embodiment is described in the following 4 steps and shown in more detail in FIG. 5 below:

Step 1: Clean up the water before it enters the evaporator

Produced water fresh off the wellpad contains more than just dissolved salt. It carries small droplets of oil, dissolved gases including hydrogen sulfide (H2S) — which is toxic and corrosive — and traces of hydrocarbons like benzene and toluene. These must be removed before anything else happens, or they will foul the equipment downstream.

The pretreatment system does this in two steps. First, the water flows through a large settling vessel. Inside, chevron-shaped baffles — think of layers of angled fins — create a calm zone where oil droplets coalesce and float to the surface to be skimmed off, while heavier solids settle to the bottom. This is a simple, mechanical process with no chemicals and no moving parts.

Second, the water enters a vacuum degassing vessel — essentially a sealed tank where the pressure is reduced below atmospheric. Dissolved gases flash out of solution (the same reason carbonation escapes when you open a soda can). Over 99% of the H2S and over 90% of the hydrocarbons are removed this way, safely captured in a vent system rather than released to the atmosphere.

After degassing, a small amount of scale-inhibiting chemical (called an anti-scalant) is added, and the pH is adjusted to a precise range. The water is now ready for the evaporator.

Step 2: Evaporate the water — three stages, one efficient system

The heart of the ZLD system is the triple-effect evaporator. The word "effect" refers to a stage of evaporation. Using three stages in sequence is the key to making the process efficient enough to be economical.

An example embodiment is described as follows: Steam enters the first evaporator vessel and heats the produced water. Some of the water evaporates. That vapor — which is now essentially pure water steam — is routed to the second vessel, where it acts as the heat source. The process repeats into a third vessel. By the time steam enters one end and liquid exits the other, the system has gotten roughly 2.6 units of water evaporated for every 1 unit of steam consumed. A single-stage evaporator only gets about 0.9 units per unit of steam. This triple-effect design is 65–70% more energy efficient than the simplest alternative.

Step 3: Crystallize the salt

The brine leaving the third evaporator stage is now extremely concentrated — close to the point where it cannot hold any more dissolved mineral. It enters a crystallizer, a vessel where the remaining water is boiled off under gentle vacuum conditions and the salts begin to form crystals.

The crystal slurry is then fed to a centrifuge or filter press, which spins or squeezes out the remaining liquid. The output is a moist salt cake — predominantly sodium chloride with calcium, magnesium, and other mineral salts — that dries to roughly 10% moisture. The liquid that drains out of the centrifuge goes back to the crystallizer to recover any remaining salts. Nothing is wasted.

The result is a dry, granular solid that passes regulatory toxicity tests and can be disposed of in a Class II on-site landfill — essentially a carefully engineered lined pit on the lease — or in some cases sold as an industrial salt product.

Step 4: Dispose of the salt — on-site, permanently

An on-site Class II landfill is permitted by the Texas Railroad Commission under rules for oil and gas waste. The design is straightforward: a lined cell with a clay base and a high-density polyethylene liner to prevent any leaching to groundwater, drainage pipes to collect any liquid that filters through (which is looped back to the ZLD system, not discharged), and a monitoring program.

One acre of cell space to a depth of 20 feet handles approximately 7–10 years of salt cake from a 4,000 BPD facility. Cells can be added as needed within the lease boundary, matching the life of the field. There are no trucks hauling waste off lease. No disposal well permits to renew. The salts stay on the property that generated them.

Permian Basin produced water often contains trace amounts of naturally occurring radioactive material (NORM) — primarily radium co-precipitated with barium sulfate. The salt cake must be tested against state thresholds (typically 50–200 picocuries per gram). In most Permian applications, NORM levels in the final salt cake are within standard Class II landfill limits.

Referring to FIG. 5 an example of a triple effect ZLD Desalination Process 510. Produced water, for example from a wellpad, is sent into an oil/water separator 511. The separator 511 may use a gravity separation, it may be equipped with a chevron-coalescing package, and it may use heat to aid the separation. Structured baffles may be used to create a low-velocity zone where entrained oil droplets coalesce and float to the surface for skimming, while solids settle to the sump. No chemicals are required at this stage.

A vacuum chamber 512 is used to draw out water from the separator 511 and then send that fluid into a first saltwater flash tank 514. The de-oiled water enters a vacuum degassing vessel 512 operating at reduced absolute pressure. Dissolved H₂S and BTEX volatiles flash out of solution and are captured in a caustic scrubber (H₂S removal >99%) and a granular activated carbon (GAC) canister (BTEX removal >90%) before discharge to a safe vent or flare. Both H₂S and BTEX concentrate in the vapor phase during evaporation and would contaminate the distillate product without upstream removal. After degassing, the water is pH-adjusted to 6.8–7.2 and dosed with an anti-scalant formulation selected for the specific ion activity product of the feed water across all evaporator temperature stages simultaneously.

The pretreated brine enters a vacuum evaporation train of one, two, or three stages — referred to as effects. In the example of FIG. 5 there are three stages, or triple effect, in flash tanks 514, 530, and 540. The number of effects is selected based on capital budget, available operating cost tolerance, expected run life, and site energy infrastructure. All configurations operate within the same 45–68°C low-temperature regime and achieve full ZLD; the effect count determines thermal efficiency, not process completeness. In a multi-effect configuration, each stage operates at a successively lower absolute pressure, which lowers the boiling point and allows the steam vapor generated in one effect to serve as the heat source for the next — without any additional external steam input between stages.

The first flash tank 514 has a first recirculation loop that uses a first liquid brine stream pumped via pump 530 to its saturation pressure from the first flash tank 514 to the first condenser 515 and back through a startup heater 513 used primarily for startup operations, and finally through a letdown valve 531 that prevents the first liquid brine stream from boiling in the loop. The pump 530 increases the pressure of the first liquid brine stream.

The second flash tank 530 has a second recirculation loop that uses a second liquid brine stream pumped via pump 532 to its saturation pressure from the second flash tank 530 to the second condenser 531 and through a letdown valve 533 that prevents the second liquid brine stream from boiling in the loop. The pump 532 increases the pressure of the second liquid brine stream.

The third flash tank 540 has a third recirculation loop that uses a third liquid brine stream pumped via pump 534 to its saturation pressure from the third flash tank 540 to the third condenser 541 and through a letdown valve 535 that prevents the third liquid brine stream from boiling in the loop. The pump 534 increases the pressure of the third liquid brine stream.

The third flash tank 540 has a third steam loop that uses a third vapor stream produced by the third flash tank 540 that is compressed using an MVR compressor 516 to pressurize and further heat the third vapor stream. It is then sent through the condenser 515 where it exchanges heat with the relatively cooler pressurized first liquid brine stream from the first flash tank 514. The latent heat from the first vapor stream of flash tank 540 is absorbed as sensible heat into the first recirculation loop. The vapor stream condenses to a liquid while the extra heat added to the first liquid brine stream does not boil the liquid because it is at its saturation temperature. When the first liquid brine stream passes through letdown valve 531, it partially flashes to steam as it enters the flash tank 514. The interactions of the first recirculation loop and the first steam loop allow the condensation of distilled liquid and transfers the heat from the MVR compressor 516 into the first flash tank 514 to generate additional vapor for the steam loop. First condenser 515 outputs a first distillate stream.

The first flash tank 514 sends its vapor, the first vapor stream, to condenser 531 that is part of the second recirculation loop from flash tank 530. The second condenser 531 condenses the first vapor stream from the first flash tank 514 by heat exchanging with the relatively cooler pressurized liquid from the second flash tank 530. The latent heat from the vapor of flash tank 514 is absorbed as sensible heat into the second recirculation loop but does not boil the fluid in the second recirculation loop because of letdown valve 533. After passing through letdown valve 533 the fluid boils from the added latent heat as it is recombined with the fluid in the second flash tank 530. Second condenser 531 outputs a second distillate stream.

The second flash tank 530 sends its vapor, the second vapor stream, to condenser 541 that is part of the third recirculation loop from flash tank 540. The third condenser 541 condenses the second vapor stream from the second flash tank 530 by heat exchanging with the relatively cooler pressurized liquid from the third flash tank 540. The latent heat from the vapor of flash tank 530 is absorbed as sensible heat into the third recirculation loop but does not boil the fluid in the third recirculation loop because of letdown valve 535. After passing through letdown valve 535 the fluid boils from the added latent heat as it is recombined with the fluid in the third flash tank 540. Third condenser 541 outputs a third distillate stream. The first, second, and third distillate streams are combined to form the distilled water output and sent to water separator 520.

In this example, the heat from MVR compressor 516 is adding heat to flash tank 514 via the first condenser 515. Flash tank 514 is adding heat to the second flash tank 530 via the second condenser 531. Flash tank 530 is adding heat to the third flash tank 540 via condenser 541. Simultaneously, distilled liquid is being produced from the first condenser 515, second condenser 531, and third condenser 541.

The de-oiled water then enters a vacuum degassing vessel 512 operating at reduced absolute pressure. Dissolved H₂S and BTEX volatiles flash out of solution and are captured in a caustic scrubber (H₂S removal >99%) and a granular activated carbon (GAC) canister (BTEX removal >90%) before discharge to a safe vent or flare. Both H₂S and BTEX concentrate in the vapor phase during evaporation and would contaminate the distillate product without upstream removal. After degassing, the water is pH-adjusted to 6.8–7.2 and dosed with an anti-scalant formulation selected for the specific ion activity product of the feed water across all evaporator temperature stages simultaneously.

For example, a liquid-ring vacuum pump 522 maintains the sub-atmospheric pressure in the vapor train and handles non-condensable gas (NCG) removal. A first condenser 515 downstream of the vapor train condenses the steam from the first effect and recovers it as clean distillate. A second condenser 531 downstream of the vapor train condenses the steam from the second effect and recovers it as clean distillate. A third condenser 541 downstream of the vapor train condenses the steam from the third effect and recovers it as clean distillate. Cold trap 521 protects the vacuum pump 522 from liquid carry-over, knocking any liquid back into the water separator 520.

Optional mechanical vapor recompression (MVR) 516 can be integrated between effects to compress low-pressure vapor back to a usable heating pressure via condenser 515, effectively replacing most or all external steam input with electrical energy from a compressor.

The concentrated brine exiting the flash tank 514 in a first liquid brine stream, flash tank 530 in a second liquid brine stream, and flash tank 540 in a third liquid brine stream and may feed, via pump 517, a draft-tube baffled (DTB) crystallizer 525 operating under vacuum at approximately 35–45°C. High-velocity recirculation through a submerged propeller and draft tube maintains uniform supersaturation, promoting growth of large, filterable crystals (target median size 200–500 microns) rather than fine, hard-to-process fines. Salt crystals from the crystallizer 525 are sent to the salt bin 519.

A controlled mother-liquor recycle loop flows through saltwater liquor pot 518 and then feeds back to the flash tank 514 inlet at a rate and point specifically set to maintain crystal growth rate within the target size distribution.

Crystal slurry from the flash tanks is fed to a filter, which could be for example a shaker screen, centrifuge, or vacuum belt. The dewatered salt cake exits to bin 519 at 8–15% moisture. Mother liquor (brine or saltwater) recovered from the separator is returned via saltwater liquor pot 518 to the flash tank 514, closing the liquid loop completely. The output flow from the first recirculation loop can be combined with the output flow from saltwater liquor pot 518 prior to entering the flash tank 514.

Distillate leaving the condensers 515, 531, and 541 at less than 50 mg/L TDS meets oilfield reuse standards without further treatment. For municipal water supply, agricultural irrigation, or other broader beneficial end uses, an additional polishing stage is incorporated. This stage consists of two elements in series: a retention pond 523 followed by a granular activated carbon (GAC) contactor operated 524 on a contingency basis. A vacuum chamber 512 is used to draw out water from the separator 511 and then send that fluid into a first saltwater flash tank 514 and then to a second saltwater flash tank 530.

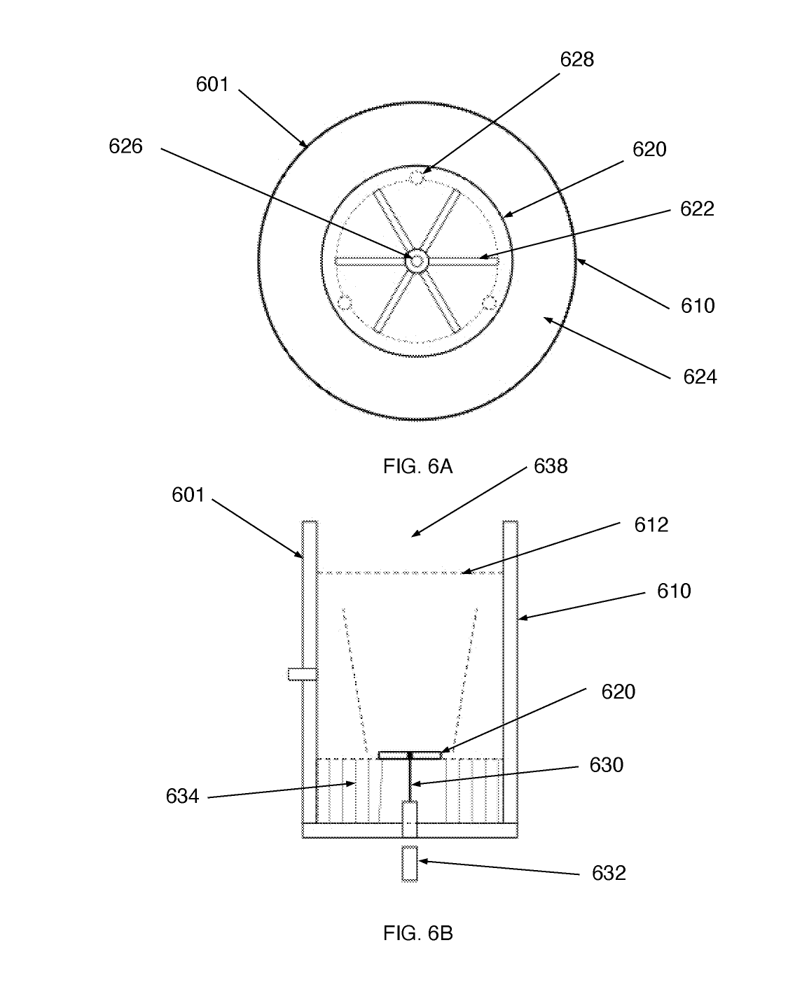

Each flash tank 314, 414, 430, 514, 530, 540 may use a submerged bottom-entry flash inlet fitted with a radially slotted deflector disk assembly 601 as shown in more detail in FIG. 6A and 6B. Incoming flash vapor and brine enter at the inlet 632 and are directed radially outward by the deflector disk 620 before being directed upward. Deflector disk 620 is located within the vessel body 610 and has an annular gap 624 between the deflector disk 620 and the vessel body 610. The deflector disk 620 is attached to center post 630 and it contains radial slots 622. Radial slots 622 in this example embodiment have a slot width of 3/16 inch, sized to be approximately 9–10 times the upper bound of the target crystal size produced by the crystallizer (200–500 micron median), which is the empirically established range for preventing crystal bridging across the slot aperture in NaCl-dominant brine service. Narrower slot widths may be used where crystal size distributions are tightly controlled below this target; wider slot widths may be preferred where feed chemistry variability produces larger crystals or agglomerates. The liquid level is 612, while the vapor outlet 638 allows vapor to exit the vessel body 610. This prevents the localized high-velocity impingement at the inlet that would otherwise drive rapid salt crystallization and accumulation at the vessel floor — a failure mode identified during bench-scale testing and addressed by this specific inlet geometry. The deflector disk is removable for inspection and cleaning via a slip-fit center post, without disassembly of the vessel. Deflector disk 620 includes center bore 626 and standoff boss 628. Flash pocket 634 is located within the base of vessel body 610. The deflector disk 601 removes the need from using a mechanical form of agitation to prevent the formation of scales or the accumulation of solids at the bottom of the flash tank. The benefit of using a passive system that uses the fluids own flow to generate agitation is a reduction of maintenance and possible downtime in remote locations.

The disclosed embodiment support three-mechanisms for scaling suppression. CaCO₃ inverse solubility (solubility increases as temperature drops, keeping CaCO₃ dissolved at 45-68 degree C that would precipitate at 90-110 degree C). BaSO₄ and SrSO₄ nucleation kinetics suppression below crystallization threshold. Amorphous silica polymerization kinetically limited below ~70 degree C.

Operating the flash evaporator at a temperature wherein CaCO₃ remains dissolved due to inverse solubility, BaSO₄ nucleation is kinetically suppressed below crystallization threshold, and amorphous silica polymerization is kinetically inhibited.

Ion activity product calculation methodology across all temperature stages simultaneously may aid in providing antiscalant control. Constraining the antiscalant formulation, such as requiring that H₂S and BTEX be removed to <1 mg/L upstream to prevent competitive adsorption interference with phosphonate inhibitors, will reduce the buildup of scalants in the equipment.

The example embodiments regulate pH in the range of 6.8-7.2 as a dual-purpose window simultaneously suppressing carbonate precipitation kinetics (lower pH shifts carbonate equilibrium toward dissolved CO₂) and protecting carbon steel heat transfer surfaces from acid corrosion.

The rate of crystal nucleation and the rate of crystal growth compete: high nucleation rates produce many small crystals (difficult to centrifuge, high moisture retention), while lower nucleation rates with sustained growth produce fewer, larger crystals that dewater efficiently. This process specifies the mother-liquor recycle loop with three defined parameters that together control the crystal size distribution: Feed-point: Mother liquor is returned at the sub-saturation inlet to the draft-tube baffled (DTB) crystallizer body — specifically, upstream of the propeller and draft tube — rather than to the brine feed line. This placement dilutes the incoming supersaturated brine before it contacts the crystal slurry, reducing the local supersaturation spike that drives excessive nucleation. Residence time: The crystallizer is sized for a crystal slurry residence time of 45–90 minutes. Below 45 minutes, crystals do not reach the target 200–500 micron median size before being withdrawn. Above 90 minutes, secondary nucleation from crystal-to-crystal and crystal-to-wall collisions begins to dominate, shifting the distribution toward fines. Recycle ratio: The volumetric recycle ratio is set as a function of inlet TDS — specifically, scaled to maintain a steady-state supersaturation ratio of 1.02–1.05 in the crystallizer body. This range is above the metastable limit (crystal growth occurs) but below the labile zone (spontaneous bulk nucleation does not occur).

The 200–500 micron target crystal size is the practical threshold for efficient centrifuge dewatering of NaCl-dominant brines. Crystals in this range achieve 85–92% solids recovery in a standard basket or pusher centrifuge with a 10–15% moisture salt cake — eliminating the need for a downstream spray dryer in most operating scenarios. The spray dryer is capital-intensive and energy-intensive; the recycle loop design avoids it.

MVR inter-effect positioning reduces scaling. The temperature differential between Effect 2 vapor and Effect 1 heating requirement represents the largest compression ratio in the train — approximately 15–25°C at the operating pressures used. This is the highest-value location for compression energy recovery. Compressing at this point rather than the inlet avoids introducing compressed steam into Effect 1 at the highest brine concentration in the train (brine concentration increases from Effect 1 to Effect 3). Feeding high-pressure steam into the most concentrated brine stage would accelerate scale initiation at the tube surfaces. Integration at this point allows live steam input to the first effect to be reduced to a startup and trim duty only, with the MVR carrying the steady-state heating load during normal operation.

Periodic acid descaling — the planned shutdown procedure required by most high-temperature evaporation systems to dissolve accumulated mineral scale from heat transfer surfaces — is not part of normal operations for this process. This is a direct consequence of the low-temperature operating regime.

At 45–68°C with pH maintained at 6.8–7.2, the dominant scaling species in Permian produced water — CaCO₃, BaSO₄, SrSO₄, and amorphous silica — remain below their respective solubility and nucleation thresholds. The antiscalant dosed at pretreatment is a threshold inhibitor and crystal habit modifier that prevents deposition; it is not a descaler and does not need to be. Provided the antiscalant program is maintained and operating temperature does not drift above the design window, mineral deposition on tube surfaces does not occur at a rate that requires remediation.

High-temperature (90-110 degree C) systems fail due to scaling using Permian produced water. The contrast with conventional high-temperature ZLD systems is significant. At 90–110°C, scale accumulation is progressive and unavoidable; operators typically plan acid-cleaning cycles every 4–12 weeks depending on feed chemistry. Each cycle takes the evaporator offline for 12–24 hours, consumes hydrochloric or citric acid, generates a spent acid waste stream requiring disposal, and gradually degrades tube wall thickness over time. The low-temperature design eliminates this maintenance burden entirely — a meaningful operational and cost advantage that compounds over the life of the asset.

The one operational caveat is feed chemistry variability. If the produced water composition shifts significantly — for example, higher barium or silica from a new producing zone — the antiscalant formulation or dose rate may need to be updated. This is a chemical program adjustment handled through routine water monitoring, not a descaling event. The bench-scale and field testing program is specifically designed to detect these shifts early and update the chemical program before any effects reach the evaporator.

The example embodiments may operate the evaporation train at 45–68°C across the three effects. At these temperatures CaCO₃ inverse solubility is exploited rather than fought. CaCO₃ solubility increases as temperature drops — the opposite of most salts — so operating at 45–68°C keeps CaCO₃ dissolved that would precipitate at higher temperatures. This is the most important scaling species in Permian produced water. BaSO₄ and SrSO₄ nucleation kinetics are suppressed below their crystallization threshold, allowing the antiscalant inhibitor (dosed at pretreatment) to maintain effective control without being overwhelmed. Amorphous silica polymerization — the mechanism by which dissolved silica forms a gel-like scale — is kinetically limited below approximately 70°C. The 45–68°C operating window keeps the system well below this threshold.

Benefits of the example embodiments may include that the process is efficient in that: 1) only a fraction of water is vaporized at low temperature and pressure, 2) recirculation and sensible heat retention minimize energy waste, 3) direct-contact heating provides 95–98% thermal efficiency, and 4) no mechanical vapor compression or high-pressure pumping is required.

Terms like produced water may refer to produced water generally in the example embodiments and in some example embodiments it refers to produced water from a wellsite in the oilfield, however this term is not intended to be limiting and the disclosed example embodiments can be used to treat produced water from other sources, such as subterranean produced water, water produced during manufacturing processes, such as microchip manufacturing, or water produced from cooling, such as in powerplants or mainframes.

The disclosed embodiments include ease of operation and attention requirements: 1) once started, the system runs continuously with minimal operator intervention, 2) key sensors (e.g., Coriolis mass meter, temperature, pressure) enable automated control of blowdown and heating, 3) salt is removed by a screen and collected in bins for occasional disposal, 4) no membranes to foul or replace, no compressors to maintain, and no scaling if the brine control is maintained.

The disclosed embodiments are robust and field suitable because: 1) the vessels may be constructed from FRP or polymer-lined low-pressure materials, 2) the system tolerates wide variations in feedwater quality, including high TDS and organics, 3) it is designed for operation in harsh environments like the Permian Basin, with ambient temperatures exceeding 110°F, and 4) air cooling may be used to eliminate the need for a secondary water source.

Although the example embodiments have been described in terms of embodiments which are set forth in detail, it should be understood that this is by illustration only and that the example embodiments are not necessarily limited thereto. The alternative embodiments and operating techniques will become apparent to those of ordinary skill in the art in view of the present disclosure. Accordingly, modifications of the example embodiments are contemplated which may be made without departing from the spirit of the claimed example embodiments.

What is claimed is:

1. A method for a zero liquid discharge desalination process comprising:
flashing produced water in a plurality of flash tanks to produce a first, second, and third vapor stream, and a first, second, and third liquid stream;
pressurizing the first, second, and third liquid streams to saturation pressure;
circulating the first vapor stream through a first condensation loop;
circulating the second vapor stream through a second condensation loop;
circulating the third vapor stream through a third condensation loop;
compressing the third vapor stream;
transferring the latent heat of the third vapor stream into sensible heat in the first liquid stream;
condensing the third vapor stream into a first distillate stream;
circulating the heated first liquid stream into the at least one flash tank; and
depressurizing the heated first liquid stream, wherein the depressurized heated first liquid stream boils due to the added sensible heat.

2. The method for a zero liquid discharge desalination process of claim 1 further comprising transferring the latent heat of the first vapor stream into sensible heat in the second liquid stream.

3. The method for a zero liquid discharge desalination process of claim 2 further comprising depressurizing the heated second liquid stream, wherein the depressurized heated second liquid stream boils due to the added sensible heat.

4. The method for a zero liquid discharge desalination process of claim 3 further comprising condensing the first vapor stream into a second distillate stream.

5. The method for a zero liquid discharge desalination process of claim 2 further comprising
transferring the latent heat of the second vapor stream into sensible heat in the third liquid stream.

6. The method for a zero liquid discharge desalination process of claim 5 further comprising depressurizing the heated third liquid stream, wherein the depressurized heated third liquid stream boils due to the added sensible heat.

7. The method for a zero liquid discharge desalination process of claim 5 further comprising condensing the second vapor stream into a third distillate stream.

8. The method for a zero liquid discharge desalination process of claim 1 further comprising circulating a liquid brine stream in a solids removal loop, wherein solids are removed from the liquid brine stream, and the remaining liquid is returned to the plurality of flash tanks.

9. The method for a zero liquid discharge desalination process of claim 1 further comprising agitating the produced water in the plurality of the flash tanks, wherein the flash tank includes a deflector disk at its base that directs incoming flow radially outward to suspend solids and prevent their accumulation at the bottom of the flash tank, without moving parts.

10. The method for a zero liquid discharge desalination process of claim 7 further comprising combining the first, second, and third distillate streams to form a combined distillate stream.

11. The method for a zero liquid discharge desalination process of claim 10 further comprising filtering combined distillate water stream through a carbon filter.

12. A method for treating produced water comprising:
separating oil from the produced water by gravity separation to produce a deoiled water stream;
removing dissolved H₂S and volatile organic compounds from the deoiled water stream by vacuum degassing prior to the evaporating step;
evaporating the pretreated water in at least one vacuum flash evaporator to produce a first vapor stream, a first liquid stream, and a first concentrated brine stream;
pressurizing the first liquid stream to at or above its saturation pressure;
pressurizing the first vapor stream;
exchanging heat between the first vapor stream and the first liquid stream to produce a first distillate liquid stream and a heated first liquid stream;
lowering the pressure of the first liquid stream prior to reentering the at least one vacuum flash evaporator, wherein the lower pressure causes the heated first liquid stream to boil inside the flash evaporator.

13. The method for treating produced water of claim 12 further comprising removing solids from the first concentrated brine stream and recirculating the first brine stream into the at least one vacuum flash evaporator.

14. The method for treating produced water of claim 12 further comprising crystallizing salts from the first concentrated brine stream.

15. The method for treating produced water of claim 12 wherein the first vapor stream is pressurized using a mechanical vapor recompression pump.

16. The method for treating produced water of claim 12 further comprising agitating the fluid in the at least one vacuum flash evaporator.

17. The method for treating produced water of claim 12, wherein the lowering of the pressure of the first liquid stream utilizes a letdown valve.

18. The method for treating produced water of claim 16, wherein the agitation is achieved using a deflector disk located inside the at least one vacuum flash evaporator.

19. The method for treating produced water of claim 12, wherein the exchanging heat between involves removing the latent heat from the first vapor stream and adding it as sensible heat into the first liquid stream.

20. The method for treating produced water of claim 12, wherein the gravity separation is performed in a vessel equipped with chevron-coalescing packing.

21. The method for treating produced water of claim 12, wherein dissolved gases released during vacuum degassing are captured in a caustic scrubber for H₂S removal and a granular activated carbon contactor for VOC removal.
